(19) United States
(12) Patent Application Publication
(10) Pub. No.: US 2013/0028159 A1
(43) Pub. Date: Jan. 31, 2013

(54) SILENT POWER-SAVE MODE FOR A WIRELESS COMMUNICATION DEVICE

(71) Applicants: Ramanuja VEDANTHAM, Allen, TX (US); Michael GLIK, Kafar Saba (IL); Xiaolin LU, Plano, TX (US)

(72) Inventors: Ramanuja VEDANTHAM, Allen, TX (US); Michael GLIK, Kafar Saba (IL); Xiaolin LU, Plano, TX (US)

(73) Assignee: TEXAS INSTRUMENTS INCORPORATED, Dallas, TX (US)

(21) Appl. No.: 13/361,217

(22) Filed: Jan. 30, 2012

Related U.S. Application Data
(60) Provisional application No. 61/437,076, filed on Jan. 28, 2011.

(51) Int. Cl. H04W 52/02; H04W 88/02

(52) U.S. Cl. 370/311

(57) ABSTRACT

In at least some embodiments, a wireless communication device includes a transceiver having control logic with a traffic learning mode and a silent power-save mode. During the traffic learning mode, the control logic is configured to determine a minimum periodicity value and a maximum periodicity value for all traffic flows served by the transceiver. During the silent power-save mode, the control logic is configured to toggle between a dozing period set to the minimum periodicity value and an active period set to a difference between the maximum periodicity value and the minimum periodicity value.

### CROSS-REFERENCE TO RELATED APPLICATIONS

The present application claims priority to U.S. Provisional Patent Application No. 61/437,076, filed on Jan. 28, 2011 (Attorney Docket No. TI-70511PS); which is hereby incorporated herein by reference.

### BACKGROUND

With the development and adoption of wireless communication technologies, consumer and business products are becoming increasingly “unwired”. For example, Wi-Fi Access Points (APs) and products that are Wi-Fi Certified® now reside in homes, businesses, and public locations. The vast number of Wi-Fi networks is a driving factor for increased penetration of Wi-Fi into consumer electronic (CE) devices and mobile handsets and the increasing adoption of Wi-Fi in devices beyond computers and APs enables new usage models for users. One usage model based on Wi-Fi adoption enables different consumer devices to share, display, print, and synchronize content in an easy and convenient manner. These usage scenarios have driven the need for peer-to-peer connectivity.

In response to peer-to-peer usage models, a task group known as “Wi-Fi Alliance” is developing a new standard called Wi-Fi Direct (also known as Wi-Fi P2P) to allow CE devices and mobile handsets to connect to each other in an ad hoc and peer-to-peer (P2P) manner. The Wi-Fi Direct specification outlines the general operation in a P2P group and specifies various rules and procedures for power-save operations at the group owner and clients. In a legacy Wi-Fi architecture, the AP does not perform power-save operations, whereas in the P2P environment it is mandated that the P2P group owner has power consumption similar to that of the P2P clients. This requirement is based on the assumption that the P2P group owner is also a CE device or mobile handset that primarily runs on limited battery supply. Efforts to reduce power consumption for P2P group devices or other wireless communication devices are ongoing.

There is a problem with determining any periodicity in the traffic currently being served at an 802.11 peer-to-peer device, such as Soft-AP or a Wi-Fi Direct group owner. Traffic characteristics are often not available at the media access control (MAC) layer and requires significant changes to the host/driver and firmware to determine them. Also, in certain scenarios where the device acts as a bridging device/gateway this information is not available in the higher communication layers.

### SUMMARY

The problems noted above are solved in large part by a wireless communication device comprising a transceiver having control logic with a traffic learning mode and a silent power-save mode. During the traffic learning mode, the control logic is configured to determine a minimum periodicity value and a maximum periodicity value for all traffic flows served by the transceiver. During the silent power-save mode, the control logic is configured to toggle between a dozing period set to the minimum periodicity value and an active period set to a difference between the maximum periodicity value and the minimum periodicity value.

Further, in at least some embodiments, a method for a wireless communication device comprises entering, by a transceiver, a traffic learning mode in response to an event. The method also comprises determining, by the transceiver, a minimum periodicity value and a maximum periodicity value for all traffic flows served by the transceiver. The method also comprises entering, by the transceiver, a silent power-save mode that toggles between a dozing period set to the minimum periodicity value and having an active period set to a difference between the maximum periodicity value and the minimum periodicity value.

Further, in at least some embodiments, a transceiver comprises control logic configured to perform traffic learning operations and non-advertized power-save operations. The traffic learning operations comprise determining a minimum periodicity value and a maximum periodicity value for all traffic flows served by the transceiver. The non-advertized power-save operations comprise toggling between a dozing period and an active period, wherein a length of the dozing period is based on the minimum periodicity value and a length of the active period is based on a difference between the maximum periodicity value and the minimum periodicity value.

### BRIEF DESCRIPTION OF THE DRAWINGS

For a more complete understanding of the present disclosure, reference is now made to the accompanying drawings and detailed description, wherein like reference numerals represent like parts:

FIG. 1 shows a communication group in accordance with an embodiment of the disclosure;

FIG. 2 shows concurrent operations of a communication group in accordance with an embodiment of the disclosure;

FIG. 3 shows timing charts related to a power-save management scheme in accordance with an embodiment of the disclosure;

FIG. 4 shows a wireless communication device in accordance with an embodiment of the disclosure;

FIG. 5 shows an exemplary computer system suitable for implementing one or more embodiments of the disclosure; and

FIG. 6 shows a method in accordance with an embodiment of the disclosure.

### NOTATION AND NOMENCLATURE

Certain terms are used throughout the following claims and description to refer to particular components. As one skilled in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean an optical, wireless, indirect electrical, or direct electrical connection. Thus, if a first device couples to a second device, that connection may be through an indirect electrical connection via other devices and connections, through a direct optical connection, etc. Additionally, the term “system” refers to a collection of two or more hardware components, and may be used to refer to an electronic device.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the disclosure are directed to power-save management for a wireless communication group. In at least some embodiments, a power-save management scheme as described herein is employed by a soft access point (SAP) device or Wi-Fi Direct group owner. Without limitation to other embodiments, the power-save management scheme can be used for any 802.11 peer-to-peer device or device with a SAP mode. Regardless of the implementing device, the power-save management scheme involves a traffic learning mode and a silent (unadvertised) power-save mode. During the traffic learning mode, a determination is made regarding whether there is any periodicity in the traffic currently being served. If there is, the traffic learning mode determines a minimum periodicity value and a maximum periodicity value for all the traffic flows being served. The disclosed power-save management scheme is simple and scalable to the number of flows served by the SAP device. The power-save management scheme also defines the trigger mechanisms to re-enter the traffic learning mode periodically or once a new flow has been identified. During the silent power-save mode, the implementing device toggles between an unadvertised doze state and an active state based on the minimum periodicity value and the maximum periodicity value as described herein.

In at least some embodiments, the designation of the traffic flow(s) served at the SAP device as periodic or bursty is based on whether a calculated minimum periodicity value and a calculated maximum periodicity value are both above a predetermined threshold (e.g., 10 ms in test simulations). If the traffic flow(s) served at the SAP device are determined to be periodic by the traffic learning mode, the silent power-save mode operates to define active periods and doze periods accordingly. In at least some embodiments, the active period for the silent power-save mode is defined as max(time slice duration, maximum periodicity−minimum periodicity). Meanwhile, the doze period for the silent power-save mode is defined as (minimum periodicity timer−active period). In such embodiments, the silent power-save mode of a SAP device may toggle a doze period set to the minimum periodicity value and an active period set to the maximum periodicity value minus the minimum periodicity value.

In at least some embodiments, the traffic learning mode is triggered for different scenarios. For example, the traffic learning mode may be triggered when a first flow traffic is detected (transmission or reception) after the link establishment frames have been sent. Additionally or alternatively, the traffic learning mode may be triggered due to a threshold amount of packets (a threshold number or percentage of packets) being transmitted/received outside the current active period. Additionally or alternatively, the traffic learning mode may be triggered due to a threshold amount of packets (a threshold number or percentage of packets) being retransmitted or received within a moving time window.

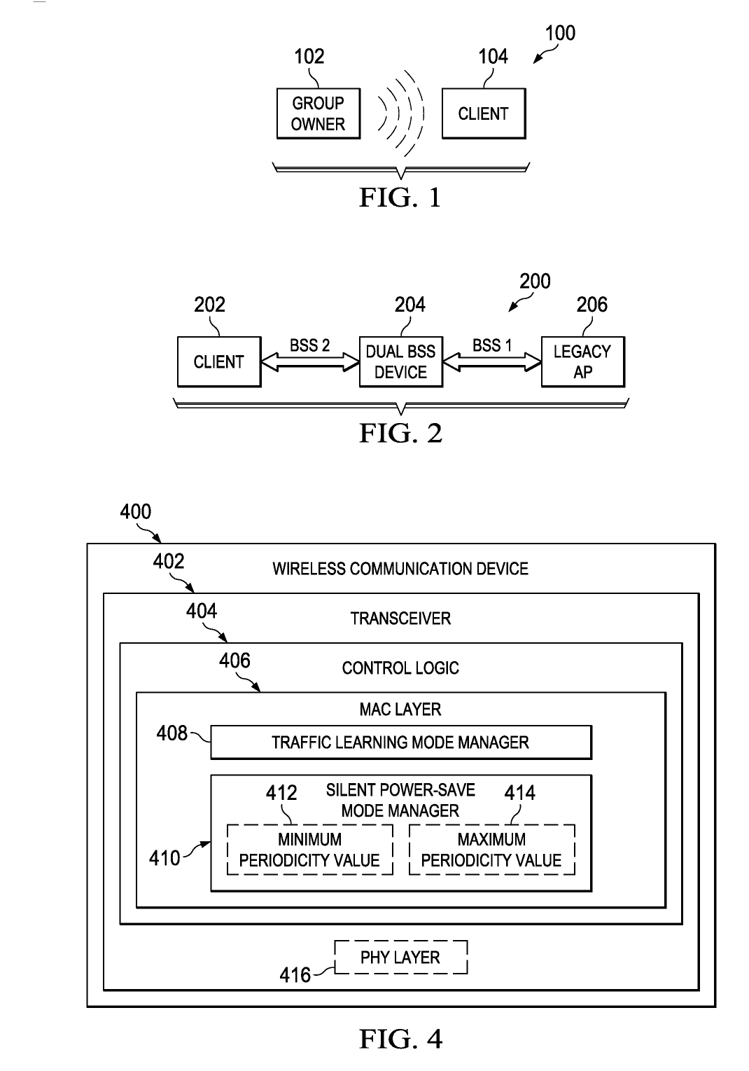

FIG. 1 shows a communication group 100 in accordance with an embodiment of the disclosure. As shown, the communication group 100 comprises a peer-to-peer (P2P) group owner 102 in communication with a P2P client 104. For example, the P2P group 102 may be a cell phone or smart phone. Meanwhile, the P2P client 104 may be a printer. In different embodiments, other consumer electronic (CE) or mobile devices may operate as a group owner or client. In at least some embodiments, the P2P group owner 102 and the P2P client 104 operate as a W-Fi Direct P2P group. In a Wi-Fi Direct P2P group, the P2P group owner (GO) behaves similar to an access point (AP) and enables P2P clients to setup and communicate in a manner similar to the conventional AP. As AP functionality is mainly provided by software, this feature is referred to herein as Soft AP (SAP). Thus, in accordance with embodiments, the P2P group owner 102 employs SAP operations in conjunction with the power-save management scheme described herein. It should be noted that the group owner 102 may operate as a SAP device for other peer-to-peer communication groups besides Wi-Fi Direct groups.

FIG. 2 shows concurrent operations of a communication group 200 in accordance with an embodiment of the disclosure. In FIG. 2, the concurrent operations are performed by a dual basic service set (BSS) device 204 that supports communications with a P2P device 202 and with a legacy AP device 206. As shown, the dual BSS device 204 communicates with the legacy AP device 206 using a first set of BSS operations (BSS 1) and communicates with the P2P device 202 a second set of BSS operations (BSS2). In this manner, the duel BSS device 204 may operate as a client of legacy AP 206 and also operates as a group owner for P2P device 202. When operating as a group owner, the dual BSS device 204 may employ SAP operations in conjunction with the power-save management scheme described herein.

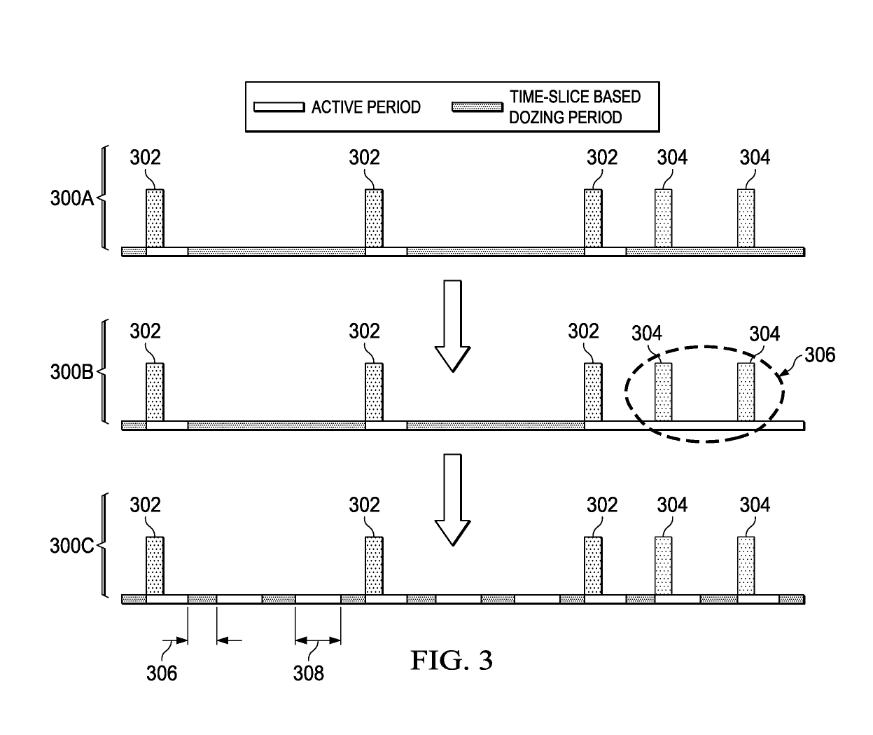

FIG. 3 shows timing charts 300A, 300B, and 300C related to a power-save management scheme in accordance with an embodiment of the disclosure. In timing chart 300A, a silent power-save mode scheme based on an initial traffic learning mode is shown. More specifically, the periodicity of traffic blocks 302 related to a periodic traffic flow has been determined and is used to set an active period and a dozing period between traffic blocks 302. However, the silent power-save mode scheme of timing chart 300A does not account for the traffic blocks 304 corresponding to a new traffic flow.

In timing chart 300B, the traffic learning mode is entered again based on a trigger such as those described herein. During the traffic learning mode, at least one dozing period of the silent power-save mode scheme is partially or entirely interrupted (i.e., one or more dozing periods are replaced with an active period or listening period) so that new traffics flows can be detected. In timing chart 300B, the traffic learning mode results in detection of traffic blocks 304 corresponding to a new traffic flow 306.

In timing chart 300C, the silent power-save mode scheme is modified based on the latest traffic learning mode results of timing chart 300B. As shown, the dozing period of timing chart 300C is set to account for the traffic blocks 302 and the traffic blocks 304. In at least some embodiments, the dozing scheme of timing chart 300C is based on toggling between a dozing period 306 having a predetermined value and an active period 308 have a predetermined value. In some embodiments, the dozing period 306 is set to a minimum periodicity value determined in the latest traffic learning mode. Meanwhile, the active period 308 is set to a maximum periodicity value minus the minimum periodicity value.

In at least some embodiments, the traffic learning mode is based on an initialization state, a transmit/receive state, and an idle listen state. In the initialization state, various parameter values are set. For example, temp_flag may be set to FALSE, min_diff_time may be set to 0.0, max_diff_time may be set to 0.0, sv_min_diff_tx_rx_time may be set to 0.1 (100 ms), and sv_max_diff_tx_rx_time may be set to 0.0. Further, periodicity_flag may be set to FALSE, global_min_periodicity may be set to 0.0, global_max_periodicity may be set to 0.0, and periodicity_THRESH may be set to 0.01 (10 ms).

The temp_flag parameter when set to TRUE is used as a boolean flag to indicate that the traffic learning period is about to end (or) has ended. The min_diff_time parameter refers to the minimum time interval between successive receptions or transmissions for the most recent window within the traffic learning period. Similarly, max_diff_time parameter refers to the maximum time interval between successive receptions or transmissions for the most recent window within the traffic learning period. The sv_min_diff_tx_rx_time parameter is a state variable used to track the minimum periodicity in the traffic flow during the traffic learning period. Similarly, the sv_max_diff_tx_rx_time parameter is a state variable used to track the maximum periodicity in the traffic flow during the traffic learning period. The periodicity flag is set at the end of the traffic learning period if it is observed that the minimum periodicity parameter (sv_max_diff_tx_rx_time) exceeds a certain threshold value. The value of the minimum periodicity parameter at the end of the traffic learning period is stored as the global_min_periodicity parameter and the value for maximum periodicity is stored as the global_max_periodicity parameter.

In the transmit/receive state, a current reception/transmission time stamp is recorded for every received/transmitted packet. If a previously recorded reception/transmission time stamp is not present (i.e., a first packet has not yet been received/transmitted), the difference between the current reception/transmission time stamp and the previous reception/transmission time stamp is not calculated. On the other hand, if a previously recorded reception/transmission time stamp is present, the difference between previous reception/transmission time stamp and the current reception/transmission time stamp is calculated. This difference value is called diff_time_tx or diff_time_rx depending on transmission or reception respectively.

In some scenarios, a client (station) connected to a SAP device may be in a power-save mode. For example, if the packet is received from a client using a PS-Poll power-save mechanism, it is necessary to track the time difference between successive PS-Poll transmissions only. The other transmissions/receptions are triggered based on the successful reception of a PS-Poll. In this case, the time difference is calculated only between successive PS-Poll packets. Also, if the packet is received from a client using an unscheduled automatic power save delivery (U-APSD) power-save mechanism, the arrival of the uplink packet from the client will be used as a trigger to send any downlink transmissions. In this case, the difference between the current reception/transmission time stamp and the previous reception/transmission time stamp may be calculated as described previously.

In the idle listen state, different operations are performed to account for expiration of a learning timer and for jitter. In the idle listen state before expiry of the learning timer, the various operations may be performed. For example, if time_after_flow_begin<1.0 s and time_afterflow_begin>T_connection frame timer (0.1 s), then min_diff_time is set to min (diff_time_tx, diff_time_rx) and max_diff_time is set to max (diff_time_tx, diff_time_rx). Also, sv_min_diff_tx_rx_time is set to min (min_diff_tx_rx_time, min_diff_time) and sv_max_diff_tx_rx_time is set to max (min_diff_tx_rx_time, min_diff_time).

In the idle listen state, jitter can be addressed before expiry of the learning timer by various operations. For example, if time_after_flow_begin>0.98 and temp_flag is FALSE, then temp_flag is set to TRUE. Also, if (sv_max_diff_tx_rx_time−sv_min_diff_tx_rx_time)<2*(time_slice_value), then sv_min_diff_tx_rx_time is set to avg (sv_min_diff_tx_rx_time, sv_max_diff_tx_rx_time) and sv_max_diff_tx_rx_time is set to sv_min_diff_tx_rx_time.

In the idle listen state, various operations may be performed after expiry of the learning timer. For example, if time_after_flow_begin>=1.0 s and if (sv_min_diff_tx_rx_time>=PERIODICITY_THRESH) and (sv_max_diff_tx_rx_time>=PERIODICITY_THRESH) and (sv_max_diff_tx_rx_time>=sv_min_diff_tx_rx_time), then periodicity_flag is set to TRUE, global_min_periodicity is set to sv_min_diff_tx_rx_time and global_max_periodicity is set to sv_max_diff_tx_rx_time. The same operations described above for the initialization state, the transmit/receive state, and the idle listen state may be performed for each instance of the traffic learning mode.

To summarize, in the initialization state, the various parameters associated with the traffic learning algorithm are set to a default value as described previously. In the transmit state, the most recent time interval between transmission of frames is monitored during the traffic learning period. In the receive state, the most recent time interval between reception of frames is calculated during the traffic learning period. In the idle listen state, the periodicity associated with a new traffic learning period is determined (if any), and the minimum and maximum periodicity is calculated (if any). The minimum and maximum periodicity are used to determine the dozing state and the active state for a silent power-save mode that follows the traffic learning period.

FIG. 4 shows a wireless communication device 400 in accordance with an embodiment of the disclosure. As shown, the wireless communication device 400 comprises a transceiver 402 with control logic 404 for performing the power-save management scheme described herein. In at least some embodiments, the control logic 404 comprises a media access control (MAC) layer 406 and a physical (PHY) layer 416, where the MAC layer 406 performs the power-save management operations described herein. To perform the power-save management operations, the MAC layer 406 comprises a traffic learning manager 408 and a silent power-save mode manager 410. In at least some embodiments, the silent power-save mode manager 410 stores or has access to the latest values available for the minimum periodicity value 412 and the maximum periodicity value 414. The minimum periodicity value 412 and the maximum periodicity value 414 may be determined by the traffic learning manager 408, which provides the traffic learning mode operations described herein.

In at least some embodiments, the traffic learning manager 408 and the silent power-save mode manager 410 may correspond to software executable by a processor. When performing the power-save management operations, the wireless communication device 400 may operate as a SAP device for a communication group (e.g., as a group owner of a Wi-Fi Direct communication group).

In accordance with embodiments, the control logic 406 may employ the traffic learning manager 408 and the silent power-save mode manager 410 to detect traffic conditions for a communication group and to enter a silent power-save mode for the different traffic conditions. As an example, the traffic learning manager 408 may cause the control logic 406 to determine a minimum periodicity value and a maximum periodicity value for all traffic flows served by the transceiver 402. During the silent power-save mode, the control logic 404 is configured to toggle between a dozing period set to the minimum periodicity value and an active period set to a difference between the maximum periodicity value and the minimum periodicity value.

In at least some embodiments, the traffic learning mode is triggered by detection of a first traffic flow after link establishment frames have been sent. Additionally or alternatively, the traffic learning mode is triggered in response to a threshold amount of communication packets being transmitted or received outside an active period. Additionally or alternatively, the traffic learning mode is triggered in response to a threshold amount of communication packets being retransmitted within a moving time window. In some embodiments, the traffic learning mode is triggered according to a predetermined schedule after link establishment frames have been sent.

During the traffic learning mode, the control logic is configured to determine and store an updated minimum periodicity value and an updated maximum periodicity value for all traffic flows served by the transceiver. Thereafter, a subsequent silent power-save mode uses the updated minimum periodicity value and the updated maximum periodicity value. In some embodiments, the control logic 404 is configured to detect a PS-Poll interval during the traffic learning mode. Thereafter, the control logic 404 may set the active period for a silent power-save mode based on the PS-Poll interval. The control logic 404 also may determine whether traffic is periodic or bursty during the traffic learning mode. If the traffic is determined to be periodic, the control logic 404 applies the silent power-save mode to the periodic traffic. If the traffic is determined to be bursty, the control logic 404 does not apply the silent power-save mode since no periodicity can be determined.

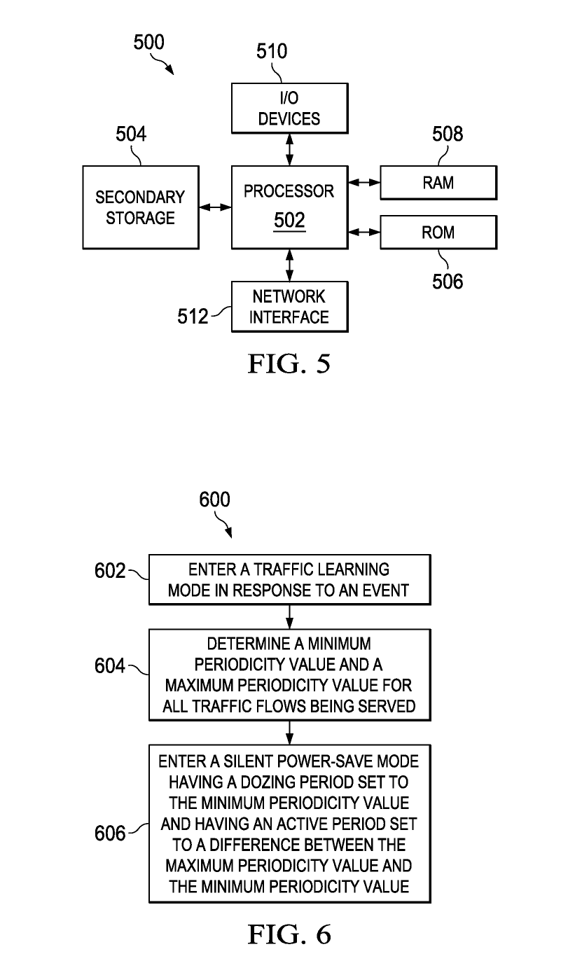

FIG. 5 shows an exemplary computer system 500 suitable for implementing one or more embodiments of the disclosure. The computer system 500 may correspond to components of each communication device described herein, such as the group owner or clients of a communication group. As shown, the computer system 500 includes a processor 502 (which may be referred to as a central processor unit or CPU) that is in communication with memory devices including secondary storage 504, read only memory (ROM) 506, and random access memory (RAM) 508. The processor 502 is also in communication with input/output (I/O) devices 510, and a network interface 512. The processor 502 may be implemented as one or more CPU chips.

It is understood that by programming and/or loading executable instructions onto the computer system 500, at least one of the CPU 502, the RAM 508, and the ROM 506 are changed, transforming the computer system 500 in part into a particular machine or apparatus having the novel functionality taught by the present disclosure. It is fundamental to the electrical engineering and software engineering arts that functionality that can be implemented by loading executable software into a computer can be converted to a hardware implementation by well known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 504 is typically comprised of one or more disk drives or tape drives and is used for non-volatile storage of data and as an over-flow data storage device if RAM 508 is not large enough to hold all working data. Secondary storage 504 may be used to store programs which are loaded into RAM 508 when such programs are selected for execution. The ROM 506 is used to store instructions and perhaps data which are read during program execution. ROM 506 is a non-volatile memory device which typically has a small memory capacity relative to the larger memory capacity of secondary storage 504. The RAM 508 is used to store volatile data and perhaps to store instructions. Access to both ROM 506 and RAM 508 is typically faster than to secondary storage 504. The secondary storage 504, the RAM 508, and/or the ROM 506 may be referred to in some contexts as computer readable storage media and/or non-transitory computer-readable media.

I/O devices 510 may include printers, video monitors, liquid crystal displays (LCDs), touch screen displays, keyboards, keypads, switches, dials, mice, track balls, voice recognizers, card readers, paper tape readers, or other well-known input devices.

The network interface 512 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. The network interface 512 may enable the processor 502 to communicate with the Internet or one or more intranets. With such a network connection, it is contemplated that the processor 502 might receive information from the network, or might output information to the network in the course of performing the above-described method steps. Such information, which is often represented as a sequence of instructions to be executed using processor 502, may be received from and outputted to the network, for example, in the form of a computer data signal embodied in a carrier wave.

Such information, which may include data or instructions to be executed using processor 502 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 502 executes instructions, codes, computer programs, scripts which it accesses from hard disk, floppy disk, optical disk (these various disk based systems may all be considered secondary storage 504), ROM 506, RAM 508, or the network interface 512. While only one processor 502 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 504, for example, hard drives, floppy disks, optical disks, and/or other device, the ROM 506, and/or the RAM 508 may be referred to in some contexts as non-transitory instructions and/or non-transitory information.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 500, at least portions of the contents of the computer program product to the secondary storage 504, to the ROM 506, to the RAM 508, and/or to other non-volatile memory and volatile memory of the computer system 500. The processor 502 may process the executable instructions and/or data structures in part by directly accessing the computer program product, for example by reading from a CD-ROM disk inserted into a disk drive peripheral of the computer system 500. Alternatively, the processor 502 may process the executable instructions and/or data structures by remotely accessing the computer program product, for example by downloading the executable instructions and/or data structures from a remote server through the network interface 512. The computer program product may comprise instructions that promote the loading and/or copying of data, data structures, files, and/or executable instructions to the secondary storage 504, to the ROM 506, to the RAM 508, and/or to other non-volatile memory and volatile memory of the computer system 500.

In some contexts, the secondary storage 504, the ROM 506, and the RAM 508 may be referred to as a non-transitory computer readable medium or a computer readable storage media. A dynamic RAM embodiment of the RAM 508, likewise, may be referred to as a non-transitory computer readable medium in that while the dynamic RAM receives electrical power and is operated in accordance with its design, for example during a period of time during which the computer 500 is turned on and operational, the dynamic RAM stores information that is written to it. Similarly, the processor 502 may comprise an internal RAM, an internal ROM, a cache memory, and/or other internal non-transitory storage blocks, sections, or components that may be referred to in some contexts as non-transitory computer readable media or computer readable storage media.

In at least some embodiments, a non-transitory computer-readable medium, such as those mentioned above, may store control logic or instructions that, when executed, causes the processor 502 to perform various operations. In some embodiments, the control logic may be part of a transceiver and may correspond to MAC layer instructions. As an example, the control logic, when executed, may cause the processor 502 to perform traffic learning operations and non-advertized power-save operations. The traffic learning operations may correspond to determining a minimum periodicity value and a maximum periodicity value for all traffic flows served by the transceiver. Meanwhile, the non-advertized power-save operations may correspond to toggling between a dozing period and an active period. In some embodiments, the length of the dozing period is based on the minimum periodicity value, and the length of the active period is based on a difference between the maximum periodicity value and the minimum periodicity value. Without limitation to other embodiments, the traffic learning operations may be initiated in response to detection of a first traffic flow after link establishment frames have been sent. Further, the traffic learning operations may be initiated in response to a detection that a threshold amount of communication packets are transmitted or received outside an active period and/or in response to detecting that a threshold amount of communication packets are retransmitted within a moving time window.

In accordance with embodiments, the control logic causes the processor 502 to perform the traffic learning operations a plurality of times, to track updates for the minimum periodicity value and the maximum periodicity value for all traffic flows served by a transceiver, and to update the dozing period and the active period based on the updates. The traffic learning operations performed by the processor 502 identify whether traffic is periodic or bursty. For periodic traffic, the non-advertised power-save operations is performed. For bursty traffic, the non-advertised power-save operations are not performed.

FIG. 6 shows a method 600 in accordance with an embodiment of the disclosure. The method 600 may be performed, for example, by a transceiver of a SAP device operating as group owner of a communication group. As shown, the method 600 comprises entering a traffic learning mode in response to an event (block 602). The event may correspond to a detection of a first traffic flow after link establishment frames have been sent, a detection that a threshold amount of communication packets are transmitted or received outside an active period, or a detection that a threshold amount of communication packets are retransmitted within a moving time window. The method 600 also comprises determining a minimum periodicity value and a maximum periodicity value for all traffic flow being served (block 604). Finally, the method 600 may comprise entering a silent power-save mode having a dozing period set to the minimum periodicity value and having an active period set to a different between the maximum periodicity value and the minimum periodicity value (block 606).

The method 600 may comprise additional or alternative steps. For example, the method 600 may additionally comprise entering the traffic learning mode a plurality of times and tracking updates for the minimum periodicity value and the maximum periodicity value for all traffic flows served by the transceiver, and updating the dozing period and the active period based on the updates. Further, the method 600 may additionally comprise detecting a PS-Poll interval during the traffic learning mode and setting the active period for the silent power-save mode based on the PS-Poll interval. Further, the method 600 may additionally comprise determining whether traffic is periodic or bursty, and entering the silent power-save mode for periodic traffic, but not for bursty traffic.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A wireless communication device comprising:
a transceiver having control logic with a traffic learning mode and a silent power-save mode,
wherein, during the traffic learning mode, the control logic is configured to determine a minimum periodicity value and a maximum periodicity value for all traffic flows served by the transceiver,
wherein, during the silent power-save mode, the control logic is configured to toggle between a dozing period set to the minimum periodicity value and an active period set to a difference between the maximum periodicity value and the minimum periodicity value.

2. The wireless communication device of claim 1, wherein the traffic learning mode is triggered by detection of a first traffic flow after link establishment frames have been sent.

3. The wireless communication device of claim 1, wherein the traffic learning mode is triggered in response to a threshold amount of communication packets being transmitted or received outside an active period.

4. The wireless communication device of claim 1, wherein the traffic learning mode is triggered in response to a threshold amount of communication packets being retransmitted within a moving time window.

5. The wireless communication device of claim 1, wherein the traffic learning mode is triggered according to a predetermined schedule after link establishment frames have been sent.

6. The wireless communication device of claim 1, wherein during the traffic learning mode, the control logic is configured to determine and store an updated minimum periodicity value and an updated maximum periodicity value for all traffic flows served by the transceiver, and wherein a subsequent silent power-save mode uses the updated minimum periodicity value and the updated maximum periodicity value.

7. The wireless communication device of claim 1, wherein during the traffic learning mode, the control logic is configured to detect a PS-Poll interval, and wherein during the silent power-save mode, the control logic sets the active period based on the PS-Poll interval.

8. The wireless communication device of claim 1, wherein during the traffic learning mode, the control logic is configured to determine whether traffic is periodic or bursty, and wherein control logic is configured to apply the silent power-save mode to periodic traffic and not to bursty traffic.

9. A method for a wireless communication device comprising:
entering, by a transceiver, a traffic learning mode in response to an event;
determining, by the transceiver, a minimum periodicity value and a maximum periodicity value for all traffic flows served by the transceiver;
entering, by the transceiver, a silent power-save mode that toggles between a dozing period set to the minimum periodicity value and having an active period set to a difference between the maximum periodicity value and the minimum periodicity value.

10. The method of claim 9, wherein the event comprises detection of a first traffic flow after link establishment frames have been sent.

11. The method of claim 9, wherein the event comprises detecting that a threshold amount of communication packets are transmitted or received outside an active period.

12. The method of claim 9, wherein the event comprises detecting that a threshold amount of communication packets are retransmitted within a moving time window.

13. The method of claim 9, further comprising entering the traffic learning mode a plurality of times and tracking updates for the minimum periodicity value and the maximum periodicity value for all traffic flows served by the transceiver, and updating the dozing period and the active period based on the updates.

14. The method of claim 9, further comprising detecting a PS-Poll interval during the traffic learning mode and setting the active period for the silent power-save mode based on the PS-Poll interval.

15. The method of claim 9, further comprising determining whether traffic is periodic or bursty, and entering the silent power-save mode for periodic traffic, but not for bursty traffic.

16. A transceiver comprising:
control logic configured to perform traffic learning operations and non-advertized power-save operations,
wherein the traffic learning operations comprise determining a minimum periodicity value and a maximum periodicity value for all traffic flows served by the transceiver,
wherein the non-advertized power-save operations comprise toggling between a dozing period and an active period, wherein a length of the dozing period is based on the minimum periodicity value and a length of the active period is based on a difference between the maximum periodicity value and the minimum periodicity value.

17. The transceiver of claim 16, wherein the traffic learning operations are initiated in response to detection of a first traffic flow after link establishment frames have been sent.

18. The transceiver of claim 16, wherein the traffic learning operations are initiated in response to at least one of detection that a threshold amount of communication packets are transmitted or received outside an active period and detecting that a threshold amount of communication packets are retransmitted within a moving time window.

19. The transceiver of claim 16, wherein the control logic is configured to perform the traffic learning operations a plurality of times, to track updates for the minimum periodicity value and the maximum periodicity value for all traffic flows served by the transceiver, and to update the dozing period and the active period based on the updates.

20. The transceiver of claim 16, wherein the traffic learning operations identify whether traffic is periodic or bursty, and wherein the non-advertised power-save operations are performed for periodic traffic, and not for bursty traffic.
